(19) United States
(12) Patent Application Publication
(10) Pub. No.: US 2008/0044688 A1
(43) Pub. Date: Feb. 21, 2008

(54) LONGITUDINAL MAGNETIC RECORDING MEDIUM AND METHOD OF MANUFACTURING THE SAME

(75) Inventors: Tuqiang Li, Minami-Alps City (JP); Manabu Shimosato, Minami-Alps City (JP); Toyoji Ataka, Minami-Alps City (JP); Hiromi Ono, Minami-Alps City (JP); Kenichiro Soma, Minami-Alps City (JP); Hiroyuki Uwazumi, Minami-Alps City (JP); Souta Matsuo, Minami-Alps City (JP)

Correspondence Address: ROSSI, KIMMS & McDOWELL LLP., P.O. BOX 826, ASHBURN, VA, 20146-0826, US

(73) Assignee: FUJI ELECTRIC DEVICE TECHNOLOGY CO., LTD., Tokyo (JP)

(21) Appl. No.: 11/683,353

(22) Filed: Mar. 7, 2007

(30) Foreign Application Priority Data
Aug. 21, 2006 (JP) 2006-223776

(51) Int. Cl. G11B 5/66; B05D 5/12

(52) U.S. Cl. 428/831; 427/128

(57) ABSTRACT

A high-recording-density magnetic recording medium and a method of its manufacture can achieve a high OR with only a small reduction in Hcr. The magnetic recording medium has a nonmagnetic substrate and a first seed layer, a second seed layer, a first underlayer, a second underlayer, and a magnetic recording layer formed on the substrate in this order. The first seed layer can be a single layer or a plurality of layers made of at least one material selected from the group consisting of Ni—Ti alloys, Cr—Al alloys, Cr—Ta alloys, and Cr—Ti alloys. The second seed layer can be a single layer or a plurality of layers made of at least one material selected from the group consisting of Ni—W alloys, Ni—Ru—W alloys, and Co—W alloys. The first underlayer can be a single layer or a plurality of layers made of a Cr—Ru alloy. The second underlayer can be a single layer or a plurality of layers made of a Cr alloy comprising Cr and at least one element selected from the group consisting of Mo, B, Ti, and W. The second seed layer is formed by sputtering while applying a substrate bias voltage to the substrate. The surface of the second seed layer can be subject to a plasma processing or exposed to an oxygen-containing atmosphere or both.

### BACKGROUND

A hard disk magnetic recording medium is typically composed of a nonmagnetic metal underlayer, a metal magnetic recording layer, a protective layer, and a lubricant layer formed on a nonmagnetic substrate, such as an aluminum alloy, glass, or the like. The nonmagnetic metal underlayer, the metal magnetic recording layer, and the protective layer can be formed by sputtering in a high vacuum. The lubricant layer can be formed by dip coating. Recording and playback of signals recorded on the medium are achieved with a magnetic head.

Ordinarily, for a magnetic recording medium substrate using an aluminum material, an aluminum alloy substrate is plated with Ni—P, and the surface thereof is subjected to texturing, namely forming circumferential grooves. In the case of a glass substrate, the surface of the glass substrate is textured directly. The nonmagnetic metal underlayer, the metal magnetic recording layer, a carbon protective layer, and so on are formed in this order on the textured surface under a high vacuum environment.

As a nonmagnetic metal underlayer, a Cr or Cr alloy underlayer (hereinafter referred to as a “Cr type underlayer”) is well known. When forming the underlayer, by controlling process conditions for oxygen exposure, substrate heating and so on, the crystal orientation of the Cr type underlayer is made to be bcc (100), and then a Co alloy magnetic recording layer is grown epitaxially thereon with hcp (110) orientation. The hcp [001] axis of easy magnetization of the Co alloy magnetic recording layer becomes parallel to the substrate surface, so that the remanent magnetization (Mr) in a direction parallel to the surface of the substrate can be made to be greater than that perpendicular to the surface of the substrate.

Moreover, when the Cr type underlayer is grown with the bcc (100) orientation, due to the circumferential grooves on the substrate surface produced through texturing, the in-plane spacing of the bcc (011) planes in the circumferential direction of the substrate becomes less than the in-plane spacing of the bcc (0 l̅1) planes in the radial direction of the substrate. Due to this difference in the in-plane spacing, the hcp [001] direction of an intermediate layer or the Co alloy magnetic recording layer heteroepitaxially grown on the underlayer tends to be oriented parallel to the circumferential direction. Because the hcp [001] direction of the Co alloy magnetic recording layer is the axis of easy magnetization, a difference arises in the Mr of the magnetic recording layer between the circumferential direction and the radial direction. Taking the product of the Mr in the circumferential direction and the thickness (t) to be Mrt_{cir}, and the product of the Mr in the radial direction and the thickness to be Mrt_{rad}, this difference is represented by OR=Mrt_{cir}/Mrt_{rad}. The higher the extent to which the hcp [001] direction of the polycrystalline Co alloy magnetic recording layer is oriented in the circumferential direction, the higher the OR.

By increasing the OR of a magnetic recording medium, Mrt_{cir} is increased, so that the playback output of a recorded signal is increased and the signal-to-noise ratio (SNR) is increased. Various ways have thus been attempted to increase the OR. For example, for a magnetic recording medium using a glass substrate, the OR is increased by depositing one or a plurality of seed layers between the Cr type underlayer and the textured substrate. See for example Japanese Patent Application Laid-open No. 2003-30825, Japanese Patent Application Laid-open No. 2004-39196, and USPGP No. 2004/258925. Moreover, it is known that the OR can be increased by exposing the surface of the seed layer to an oxygen-containing gas atmosphere before forming the underlayer. See for example Japanese Patent Application Laid-open No. 2003-30825 and Japanese Patent Application Laid-open No. 2004-39196.

To realize a high recording density of more than 100 Gbit/inch² with a longitudinal magnetic recording medium, the OR must be further increased. As the OR is increased, however, the magnetic film thickness decreases at which the same output is obtained. As the magnetic layer becomes thinner, from the viewpoint of thermal stability, the coercivity (Hcr) of the medium must be increased. Furthermore, it is known that with regard to increasing the track density (TPI) in the radial direction of the medium, data written to a neighboring track is less prone to being deleted for a medium having a high Hcr, which is effective for increasing the TPI.

With the above method in which the seed layer is exposed to oxygen before forming the underlayer, the OR can be increased, but there is a problem in that as the oxygen partial pressure or the exposure time is increased, the coercivity of the magnetic layer is reduced due to oxygen being adsorbed onto the surface of the seed layer. Accordingly, there remains a need for a longitudinal magnetic recording medium having a larger OR while minimizing the reduction of the coercivity. The present invention addresses this need.

### SUMMARY OF THE INVENTION

The present invention relates to a longitudinal magnetic recording medium, such as used in a hard disk drive (HDD) or the like, and a method of manufacturing the same. In particular, the present invention relates to a high-recording-density magnetic recording medium that can achieve a high OR with only a small reduction in the Hcr.

One aspect of the present invention is a longitudinal magnetic recording medium. The medium includes a nonmagnetic substrate, and a seed layer, an underlayer, and a magnetic recording layer on the magnetic substrate in this order. The medium can further include an intermediate layer between the underlayer and the magnetic recording layer.

The surface of the nonmagnetic substrate has a texture in the form of circumferential grooves, the grooves having a density of not less than 10 per μm, and a substrate roughness in a range of 0.1 to 1 nm.

The seed layer comprises a first seed layer and a second seed layer on the first seed layer. The first seed layer comprises at least one layer composed of at least one material selected from the group consisting of Ni—Ti alloys, Cr—Al alloys, Cr—Ta alloys, and Cr—Ti alloys. The second seed layer comprises at least one layer composed of at least one material selected from the group consisting of Ni—W alloys, Ni—Ru—W alloys, and Co—W alloys.

Each of the first seed layer and the second seed layer can have an amorphous structure. The first seed layer can have a thickness in a range of 4 to 20 nm, and the second seed layer can have a thickness in a range of 2 to 12 nm. If the first seed layer contains the Ni—Ti alloy, the Ni—Ti alloy can have a Ti content in a range of 20 to 80 at %. If the second seed layer contains the Ni—W alloy, the Ni—W alloy can have a W content in a range of 20 to 80 at %.

The underlayer can include a first underlayer and a second underlayer on the first underlayer. The first underlayer can comprise at least one layer composed of a Cr—Ru alloy. The second underlayer can comprise at least one layer composed of a Cr alloy of Cr and at least one element selected from the group consisting of Mo, B, Ti, and W. The first and second underlayers each can have a Cr content in a range of 60 to 95 at %. The first underlayer can have a thickness in a range of 1 to 7 nm.

The magnetic recording layer can comprise at least one layer composed of at least one material selected from the group consisting of Co—Cr—Pt—B alloys and Co—Cr—Pt—B—Cu alloys.

Another aspect of the present invention is a method of manufacturing the above described longitudinal magnetic recording medium. The method can include providing the nonmagnetic substrate, and forming the seed layer, the underlayer, and the magnetic recording layer on the nonmagnetic substrate in this order. The second seed layer is formed by sputtering while applying a substrate bias voltage to the nonmagnetic substrate. The substrate bias voltage can be in a range of −30 to −500 V.

The surface of the second seed layer can be plasma processed, and Ar gas can be used in the plasma processing. The surface of the second seed layer also can be exposed to an oxygen-containing atmosphere. The oxygen-containing atmosphere can have an oxygen partial pressure in a range of 1×10⁻⁴ to 1 Pa.

### BRIEF DESCRIPTION OF THE DRAWINGS

FIG. 1 is a schematic sectional view for explaining an example of the structure of a longitudinal magnetic recording medium according to the present invention.

FIGS. 2A and 2B are graphs for explaining the relationship between the oxygen partial pressure and the OR, and the oxygen partial pressure and Hcr, respectively, when exposing a seed layer 2 to oxygen according to Example 1 and Comparative Example 1.

FIGS. 3A and 3B are graphs for explaining the distribution of crystal grain sizes in a magnetic layer for the magnetic recording media of Example 1 and Comparative Example 2, respectively.

FIG. 4 is a graph for explaining the relationship between the substrate bias voltage when forming a seed layer and the OR according to Example 2.

### DETAILED DESCRIPTION

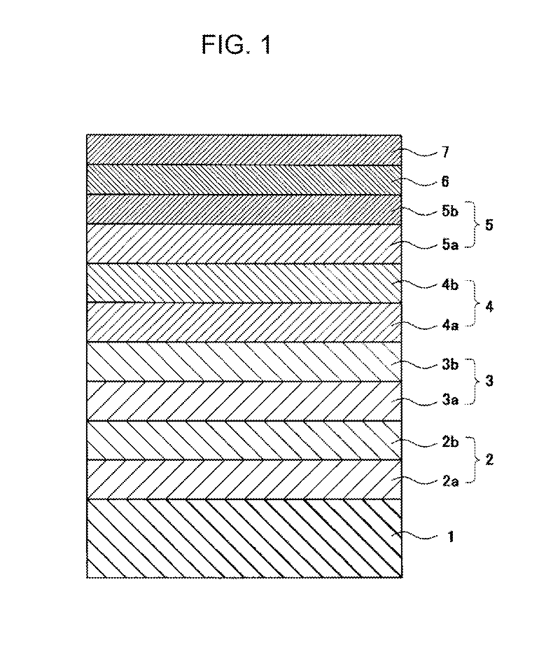

FIG. 1 is a schematic sectional view for explaining embodiments of the structure of a longitudinal magnetic recording medium. The magnetic recording medium can have a structure in which a seed layer 2, an underlayer 3, an intermediate layer 4, a magnetic recording layer 5, a protective layer 6, and a lubricant layer 7 are formed on a nonmagnetic substrate 1 in this order. The seed layer 2 comprises a first seed layer 2a and a second seed layer 2b, the underlayer 3 comprises a first underlayer 3a and a second underlayer 3b, the intermediate layer 4 comprises a first intermediate layer 4a and a second intermediate layer 4b, and the magnetic recording layer 5 comprises a first magnetic recording layer 5a and a second magnetic recording layer 5b.

The nonmagnetic substrate 1 can be an NiP-plated Al alloy, glass, tempered glass, crystallized glass, or the like, as used for a conventional magnetic recording medium. The substrate 1 is subjected to texturing. Before texturing, the substrate can be polished using a conventional technique to smooth its surface. The average surface roughness (Ra) after the polishing can be in the range of 0.2 to 0.5 nm. The surface-smoothed substrate is subjected to texturing to form substantially concentric circular grooves in a circumferential direction. The textured substrate preferably has not less than 10 concentric circular grooves per 1 μm formed thereon in the circumferential direction. At less than 10 per 1 μm, the desired Mr anisotropy cannot be obtained, thus decreasing the OR. A large number of grooves is desirable, but if the number of grooves exceeds 60 per 1 μm, then it becomes difficult to obtain a desired groove depth. Ra after the texturing can be in the range of 0.1 to 1 nm. If Ra is less than 0.1 nm, then the appearance of Mr anisotropy due to texturing is suppressed, thus decreasing the OR. If Ra exceeds 1 nm, then the magnetic head flying height increases, thus worsening the read/write performance. The thus textured substrate is washed thoroughly to remove any foreign matter from the surface thereof, and then film formation processes are carried out.

The seed layer 2 comprises the first seed layer 2a and the second seed layer 2b formed in this order. The first seed layer 2a contains a reactive metal and is for improving adhesion to the substrate. The second seed layer 2b is for controlling the crystal orientation, crystal grain size, and so on of the underlayer formed thereon, to obtain desired characteristics for the magnetic recording medium.

The first seed layer 2a is made of at least one material selected from the group consisting of Ni—Ti alloys, Cr—Al alloys, Cr—Ta alloys, and Cr—Ti alloys. The second seed layer 2b is made of at least one material selected from the group consisting of Ni—W alloys, Ni—Ru—W alloys, and Co—W alloys. Each of the first seed layer 2a and the second seed layer 2b can be a plurality of layers made of different materials from among the above materials or different compositions formed on one another.

The seed layer 2 can be amorphous. Here, “amorphous” means that other than a halo pattern, distinct diffraction peaks are not seen in an X-ray diffraction spectrum, or the mean grain size obtained from a lattice image taken with a high-resolution electron microscope is not more than 5 nm. The amorphous film can contain microcrystallite grains. By forming the seed layer 2 from an amorphous or amorphous-like film, the surface thereof becomes smooth so that the grains of a Cr—Ru alloy layer comprising the first underlayer formed on the seed layer can be made smaller or the magnetic recording layer can be made to have a higher OR.

It is undesirable for the seed layer to be a crystalline film, since then the Cr—Ru alloy of the first underlayer 3a thereon will be prone to growing epitaxially, so that the grain size will increase due to continued growth of the crystal grains, or the first (Cr—Ru alloy) underlayer 3a can become oriented with the orientation other than (100) due to the orientation of the crystal grains in the seed layer. Moreover, even in the case where the first (Cr—Ru alloy) underlayer 3a grows non-epitaxially on the seed layer, the roughness of the seed layer surface due to the growth of crystal grains in the seed layer will cause relaxation of circumferential compressive strain in the first (Cr—Ru alloy) underlayer caused by the grooves of the substrate texture, decreasing the OR. For the above reasons, an amorphous or amorphous-like seed layer is desirable for achieving a higher OR.

When the first seed layer 2a is made of an Ni—Ti alloy, the Ti content of the Ni—Ti alloy can be in the range of 20 to 80 at %. If the Ti content is less than 20 at %, or greater than 80 at %, then the film will be prone to crystallization, which will decrease the OR. When the first seed layer 2a is made of a Cr—Al alloy, the Al content of the Cr—Al alloy can be in the range of 25 to 60 at %. The reason for this is the same as in the case of the Ni—Ti alloy. When the first seed layer 2a is made of a Cr—Ti alloy, the Ti content of the Cr—Ti alloy can be in the range of 30 to 80 at %. The reason for this is the same as in the case of the Ni—Ti alloy. When the first seed layer 2a is made of a Cr—Ta alloy, the Ta content of the Cr—Ta alloy can be in the range of 30 to 80 at %. The reason for this is the same as in the case of the Ni—Ti alloy.

By reducing the surface energy of the second seed layer 2b, the crystal orientation, crystal grain size, and so on of the underlayer 3 formed on the seed layer 2 can be suitably controlled. The reason for this is thought to be as follows. The underlayer 3 preferably has a bcc (100) orientation relative to the substrate surface, but when the first underlayer 3a is composed of Cr alloy, the surface energy is lowest along the bcc (110) plane, so that the orientation is prone to becoming bcc (110). However, by reducing the surface energy of the second seed layer 2b, the wettability of the first underlayer is changed, and furthermore by using a Cr—Ru alloy for the first underlayer, bcc (100) crystal nuclei can be formed well, so that the orientation can be suitably controlled to be bcc (100).

To further reduce the surface energy of the second seed layer 2b, the surface of the seed layer 2 can be exposed to an oxygen-containing atmosphere. Through the oxygen exposure, activated bonds on the surface of the second seed layer 2b are bonded to oxygen and thus stabilized. The second seed layer 2b can be exposed an oxygen-containing atmosphere for an exposure time in the range of 1 to 4 seconds, with the oxygen partial pressure in a range of 1×10⁻⁴ to 1 Pa. If the oxygen partial pressure is less than 1×10⁻⁴ Pa or the exposure time is shorter than 1 second, then a sufficient effect of the exposure will not be obtained, so that the OR will not be improved. If the oxygen partial pressure is higher than 1 Pa or the exposure time is longer than 4 seconds, then the Hcr of the magnetic recording medium will decrease.

When forming the second seed layer 2b, by applying a negative bias voltage to the substrate, the surface of the seed layer collides with Ar⁺ ions, so that impurity gas molecules and the like become less prone to being adsorbed and activated bonds are more readily formed on the surface. As a result, after being subjected to the oxygen exposure, the surface of the seed layer will have a lower surface energy. The substrate bias voltage applied can be in the range of −30 to −500 V. If the substrate bias voltage is higher than −30 V, then a sufficient effect of the bias voltage will not be obtained, whereas if the substrate bias voltage is lower than −500 V, then it will be prone to process problems such as an abnormal electrical discharge.

For similar reasons, before exposing the surface of the seed layer to oxygen, plasma processing can be carried out so as to remove impurities from the surface to further reduce the surface energy. Moreover, after forming the seed layer 2, the substrate can be heated to 150 to 250° C. to further promote the bcc (100) orientation of the first underlayer 3a.

When the second seed layer 2b is made of an Ni—W alloy, the W content of the Ni—W alloy can be in the range of 20 to 80 at %. If the W content is less than 20 at %, then the OR will decrease. Moreover, if the W content is greater than 80 at %, then it will be prone to crystallization, which can decrease the OR. The W content can be in the range of 30 to 80 at %. If the W content is less than 30 at %, then the second seed layer 2b will become magnetic, which will worsen the characteristics.

When the second seed layer 2b is made of an Ni—Ru—W alloy, the W content of the Ni—Ru—W alloy can be in the range of 20 to 80 at %, with the Ru content not more than 50 at % and the total content of Ru and W not less than 30 at %. The reason therefor is the same as in the case of the Ni—W alloy. Moreover, if the Ru content is in the range of 5 to 50 at %, the OR can be increased more effectively. When the second seed layer 2b is made of a Co—W alloy, the W content of the Co—W alloy can be in the range of 20 to 80 at %.

The thickness of the first seed layer 2a can be in the range of 4 to 20 nm, and the thickness of the second seed layer 2b can be in the range of 2 to 12 nm. It is particularly preferable for the thickness of the first seed layer 2a to be in the range of 6 to 16 nm, and for the thickness of the second seed layer 2b to be in the range of 2 to 6 nm. When either of the first seed layer 2a or the second seed layer 2b comprises a plurality of layers formed on one another, the total thickness of the films formed on one another can be in the same range as above.

The underlayer 3 comprises the first underlayer 3a and the second underlayer 3b formed in this order. The first underlayer 3a can be made of a Cr—Ru alloy. The second underlayer 3b can be made of a Cr alloy comprising Cr and at least one element selected from the group consisting of Mo, B, Ti, and W. The second underlayer 3b can be formed of a plurality of layers having different compositions of these elements formed on one another. The first underlayer 3a can be made of a Cr—Ru alloy comprising Cr and Ru, with the Cr content in the range of 60 to 95 at %. If the Cr content is less than 60 at %, then the orientation of the first underlayer 3a will not readily become bcc (100). By making the Ru content not less than 5 at %, the decrease in the Hcr due to the exposure of the seed layer to the oxygen can be reduced. It is thought that this is because due to the presence of the Ru in the underlayer, oxygen on the surface of the seed layer does not readily diffuse into the magnetic layer, thus preventing the Hcr from decreasing. The thickness of the first underlayer 3a can be in the range of 1 to 7 nm. If the first underlayer 3a is thinner than 1 nm, then the Cr—Ru layer will remain uncrystallized, so that the OR will decrease. If the first underlayer 3a is thicker than 7 nm, then the grain size of the underlayer 3 will increase, so that the SNR will worsen.

By adding Mo, Ti, or W, each of which is a metal having a large atomic radius, to the Cr alloy of the second underlayer 3b, the lattice constants of the second underlayer can be increased to match the lattice constants of the magnetic recording layer. By making the second underlayer 3b have a plurality of layers having different compositions formed on one another, the compatibility between the lattice constants can be further improved. Moreover, by adding B to the Cr alloy of the second underlayer 3b, the crystal grain size can be made smaller. The second underlayer 3b also can have a Cr content in the range of 60 to 95 at %.

One or a plurality of intermediate layers 4 can be disposed between the underlayer 3 and the magnetic recording layer 5. Each intermediate layer 4 can be made of at least one element selected from the group consisting of Co, Cr, Ta, Ru, Pt, B, and Cu. The crystal structure of the intermediate layer 4 can be hcp. In this case, a magnetic recording layer having an hcp structure epitaxially grows well on the hcp intermediate layer, so that the SNR can be improved.

The thickness of the intermediate layer 4 can be in the range of 1 to 6 nm. If the intermediate layer is thinner than 1 nm, then the intermediate layer will not sufficiently have an hcp structure due to the influence of an initial growth layer formed through heteroepitaxial growth from a bcc structure to an hcp structure. If the intermediate layer is thicker than 6 nm, then the crystal grain size will increase, so that the SNR will worsen.

The magnetic recording layer 5 can be made of conventional magnetic recording layer material, such as a Co—Cr—Pt—B alloy or a Co—Cr—Pt—B—Cu alloy. The magnetic recording layer also can be made of a plurality of such layers formed on one another. From the viewpoint of the read/write performance, however, the composition of the magnetic recording layer can be such that the total content of Cr and B is in the range of 15 to 30 at %, the Pt content is in the range of 10 to 25 at %, and the Cu content not more than 8 at %.

Following describes working examples according to the present invention. Referring to FIG. 1, Example 1 was manufactured using, as the substrate 1, an amorphous glass substrate having a diameter of 65 mm and a thickness of 0.635 mm. The surface of the glass substrate was polished to a surface roughness Ra of 0.3 nm. Next, the glass substrate was textured by a suspended abrasive grain method using a nonwoven cloth and a diamond slurry, to form an average of 45 substantially concentric circular grooves per 1 μm in the circumferential direction. After texturing, Ra was 0.4 nm.

The glass substrate was next washed thoroughly, and was then introduced into a film forming apparatus. Unless specifically stated, a DC magnetron sputtering method was used as the film formation method, Ar gas was used as the sputtering gas, and the film formation was carried out at a gas pressure of 0.8 Pa. First, an Ni₄₀Ti₆₀ film was formed as the first seed layer 2a on the glass substrate. The formed Ni₄₀Ti₆₀ film had a thickness of 8 nm, and had an amorphous structure. Next, the second seed layer 2b was formed using an Ni₄₅W₅₅ sputtering target. First, the Ni₄₅W₅₅ was formed to 2.5 nm, and then while continuing the target electrical discharge, a −150 V bias voltage was applied to the substrate, and additional 2.5 nm of Ni₄₅W₅₅ was formed. The Ni—W had an amorphous structure.

Before forming the underlayer 3, the substrate on which the two-layer seed layers 2a, 2b had been formed was exposed for 2 seconds in the atmosphere of Ar gas with 30 vol % of O₂ added thereto, the oxygen partial pressure being in the range of 0.01 to 0.4 Pa, thus adsorbing oxygen onto the surface of the Ni₄₅W₅₅ second seed layer 2b.

Next, the substrate was heated to 210° C. using a heater, and then the underlayer 3 was formed. First, a first underlayer 3a made of Cr₉₀Ru₁₀ was formed to a thickness of 3.8 nm using a sputtering target made of Cr₉₀Ru₁₀. Next, a CrMo second underlayer 3b of the two-layer structure was formed. The CrMo layer was formed to a thickness of 1.9 nm using a Cr₇₀Mo₃₀ sputtering target.

Next, the intermediate layer 4 was formed. First, a CoCrTa first intermediate layer 4a was formed to a thickness of 3 nm using a CO₇₄Cr₂₂Ta₄ sputtering target, and then an Ru second intermediate layer 4b was formed to a thickness of 0.8 nm using a pure Ru sputtering target.

Next, a magnetic recording layer 5 having a two-layer structure was formed. First, a first magnetic recording layer 5a was formed to a thickness of 10.8 nm using a CO₅₃Cr₂₅Pt₁₄B₈ sputtering target, and then a second magnetic recording layer 5b was formed to a thickness of 7.2 nm using a CO₆₄Cr₁₃Pt₁₃B₁₀ sputtering target.

A protective layer 6 made of carbon was then formed using a PECVD method and a sputtering method. A layer was first formed to a thickness of 2.0 nm by the PECVD method using ethylene gas, and then a layer was formed to a thickness of 0.8 nm by the sputtering method using a carbon target.

Next, a lubricant made of a perfluoropolyether was coated on to 1.2 nm using a dip coating method, thus obtaining a magnetic recording medium, which was taken as Example 1.

Example 2 of a magnetic recording medium according to the present invention was manufactured as in Example 1, except that the substrate bias voltage and the oxygen partial pressure were changed. In Example 2, the substrate bias voltage when forming the Ni₄₅W₅₅ second seed layer 2b was applied in the range of 0 to −200 V, and the surface of the Ni₄₅W₅₅ second seed layer was exposed to oxygen with the oxygen partial pressure of 0.2 Pa.

Comparative Example 1 of a magnetic recording medium was manufactured as in Example 1, except that the first underlayer 3a was formed to a thickness of 3.8 nm using a pure Cr sputtering target. Comparative Example 2 of a magnetic recording medium was manufactured as in Example 1, except that the first seed layer 2a was formed to a thickness of 3.8 nm in an N₂ atmosphere using a pure Cr target, and then the second seed layer 2b was formed to a thickness of 12 nm using an Ni₆₃Ta₃₇ sputtering target.

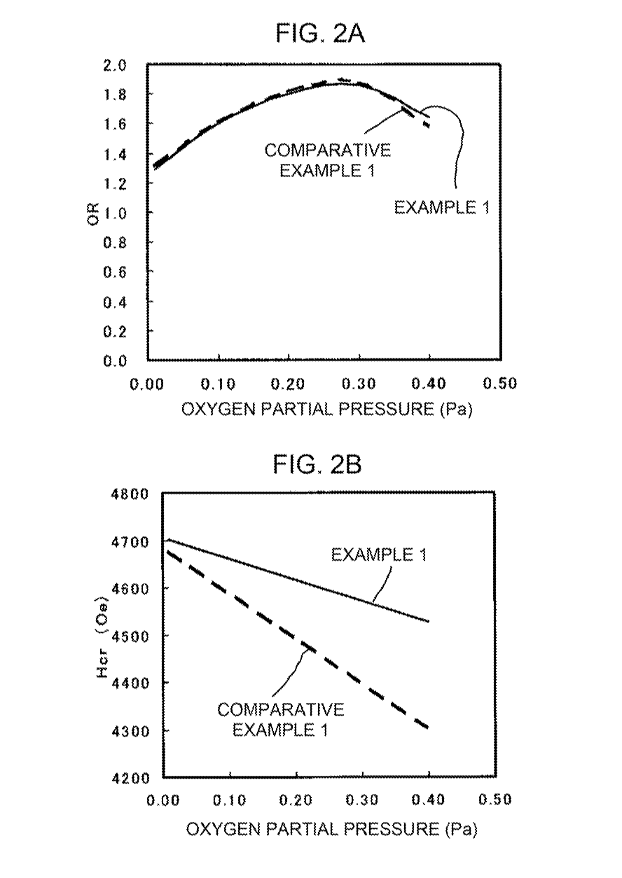

FIGS. 2A and 2B show data on the dependence of the OR and the Hcr respectively on the oxygen partial pressure in the oxygen exposure for the magnetic recording media of Example 1 and Comparative Example 1. In the case of Example 1, the deterioration in the Hcr with increasing oxygen partial pressure was more gradual than in the case of Comparative Example 1, as is shown in FIG. 2B.

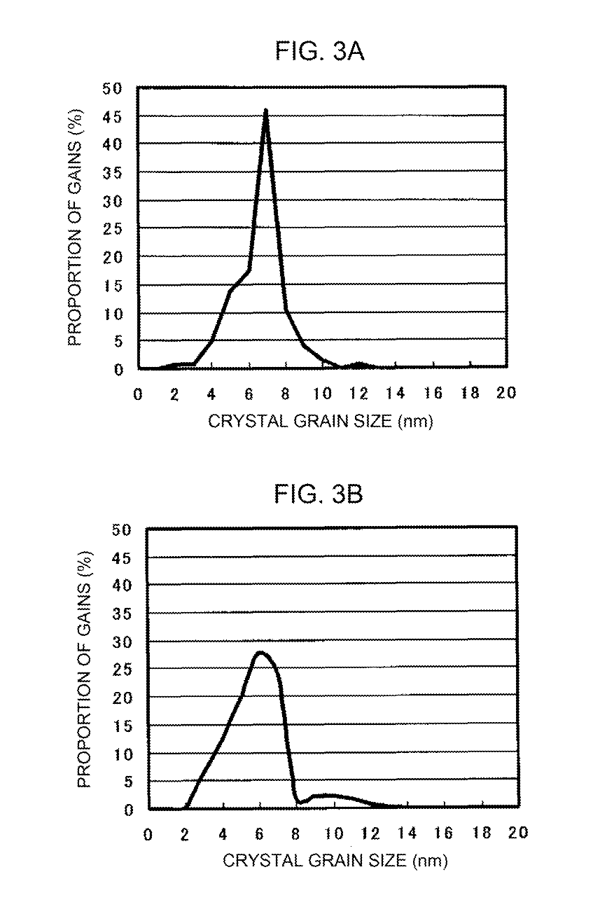

FIGS. 3A and 3B show data on the distribution of crystal grain sizes in the magnetic layer for the magnetic recording media of Example 1 and Comparative Example 2. FIG. 3A shows the case of Example 1, and FIG. 3B shows the case of Comparative Example 2. It can be seen that in the case of the seed layer of Example 1, the distribution of crystal grain sizes in the magnetic layer was narrower than in the case of Comparative Example 2.

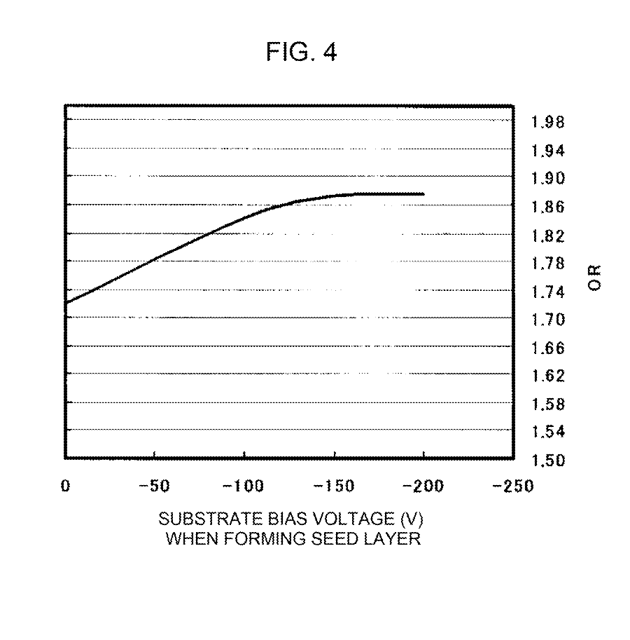

FIG. 4 is a graph for explaining the relationship between the substrate bias voltage when forming the Ni₄₅W₅₅ second seed layer 2b and the OR for the magnetic recording media of Example 2. In the substrate bias voltage range of 0 to −150 V, as the absolute value of the bias voltage increases, the OR increases. When the bias voltage exceeds (in terms of the absolute value) −150 V, the OR saturates and does not increase further with increase in the absolute bias voltage.

While the present invention has been particularly shown and described with reference to preferred embodiment thereof, it will be understood by those skilled in the art that the foregoing and other changes in form and details can be made therein without departing from the spirit and scope of the present invention. All modifications and equivalents attainable by one versed in the art from the present disclosure within the scope and spirit of the present invention are to be included as further embodiments of the present invention. The scope of the present invention accordingly is to be defined as set forth in the appended claims.

This application is based on, and claims priority to, JP PA 2006-223776 filed on 21 Aug. 2006. The disclosure of the priority application, in its entirety, including the drawings, claims, and the specification thereof, is incorporated herein by reference.

What is claimed is:

1. A longitudinal magnetic recording medium comprising:
a nonmagnetic substrate; and
a seed layer, an underlayer, and a magnetic recording layer on the magnetic substrate in this order,
wherein the seed layer comprises a first seed layer and a second seed layer on the first seed layer,
wherein the first seed layer comprises at least one layer composed of at least one material selected from the group consisting of Ni—Ti alloys, Cr—Al alloys, Cr—Ta alloys, and Cr—Ti alloys,
wherein the second seed layer comprises at least one layer composed of at least one material selected from the group consisting of Ni—W alloys, Ni—Ru—W alloys, and Co—W alloys,
wherein the underlayer comprises a first underlayer and a second underlayer on the first underlayer,
wherein the first underlayer comprises at least one layer composed of a Cr—Ru alloy, and
wherein the second underlayer comprises at least one layer composed of a Cr alloy of Cr and at least one element selected from the group consisting of Mo, B, Ti, and W.

2. The longitudinal magnetic recording medium according to claim 1, wherein each of the first seed layer and the second seed layer has an amorphous structure.

3. The longitudinal magnetic recording medium according to claim 1, wherein the surface of the nonmagnetic substrate has a texture in the form of circumferential grooves, the grooves having a density of not less than 10 per μm, and a substrate roughness in a range of 0.1 to 1 nm.

4. The longitudinal magnetic recording medium according to claim 1, wherein the first seed layer has a thickness in a range of 4 to 20 nm, and the second seed layer has a thickness in a range of 2 to 12 nm.

5. The longitudinal magnetic recording medium according to claim 1, wherein the first seed layer contains the Ni—Ti alloy, the Ni—Ti alloy having a Ti content in a range of 20 to 80 at %.

6. The longitudinal magnetic recording medium according to claim 1, wherein the second seed layer contains the Ni—W alloy, the Ni—W alloy having a W content in a range of 20 to 80 at %.

7. The longitudinal magnetic recording medium according to claim 1, wherein the first underlayer has a Cr content in a range of 60 to 95 at %.

8. The longitudinal magnetic recording medium according to claim 1, wherein the first underlayer has a thickness in a range of 1 to 7 nm.

9. The longitudinal magnetic recording medium according to claim 1, wherein the second underlayer has a Cr content in a range of 60 to 95 at %.

10. The longitudinal magnetic recording medium according to claim 1, wherein the magnetic recording layer comprises at least one layer composed of at least one material selected from the group consisting of Co—Cr—Pt—B alloys and Co—Cr—Pt—B—Cu alloys.

11. The longitudinal magnetic recording medium according to claim 1, further including an intermediate layer between the underlayer and the magnetic recording layer.

12. A method of manufacturing a longitudinal magnetic recording medium comprising the steps of:
providing a nonmagnetic substrate; and
forming a seed layer, an underlayer, and a magnetic recording layer on the nonmagnetic substrate in this order,
wherein the seed layer comprises a first seed layer and a second seed layer on the first seed layer,
wherein the first seed layer comprises at least one layer composed of at least one material selected from the group consisting of Ni—Ti alloys, Cr—Al alloys, Cr—Ta alloys, and Cr—Ti alloys,
wherein the second seed layer comprises at least one layer composed of at least one material selected from the group consisting of Ni—W alloys, Ni—Ru—W alloys, and Co—W alloys,
wherein the second seed layer is formed by sputtering while applying a substrate bias voltage to the nonmagnetic substrate,
wherein the underlayer comprises a first underlayer and a second underlayer on the first underlayer,
wherein the first underlayer comprises at least one layer composed of a Cr—Ru alloy, and
wherein the second underlayer comprises at least one layer composed of a Cr alloy of Cr and at least one element selected from the group consisting of Mo, B, Ti, and W.

13. The method according to claim 12, wherein the substrate bias voltage is in a range of −30 to −500 V.

14. The method according to claim 12, further including the step of subjecting the surface of the second seed layer to plasma processing.

15. The method according to claim 14, wherein Ar is used in the plasma processing.

16. The method according to claim 12, further including the step of exposing the surface of the second seed layer to an oxygen-containing atmosphere.

17. The method according to claim 16, wherein the oxygen-containing atmosphere has an oxygen partial pressure in a range of 1×10⁻⁴ to 1 Pa.
